(19) United States
(12) Patent Application Publication
(10) Pub. No.: US 2006/0287616 A1
(43) Pub. Date: Dec. 21, 2006

(54) Massager device with liquid applicator

(75) Inventor: Simon Siu Man Nan, Ontario (CA)

Correspondence Address: GREENSFELDER HEMKER & GALE PC, SUITE 2000, 10 SOUTH BROADWAY, ST LOUIS, MO, 63102, US

(73) Assignee: NANMA MANUFACTURING CO. LTD.

(21) Appl. No.: 11/157,630

(22) Filed: Jun. 21, 2005

(51) Int. Cl. A61H 19/00

(52) U.S. Cl. 601/17; 601/DIG. 16; 601/70; 601/72; 600/38; 601/DIG. 2

(57) ABSTRACT

A massager device that provides a liquid applicator that dispenses a liquid and provides a massaging effect is disclosed. The massager device comprises a massage head adapted to engage a reservoir for storing a liquid, a liquid dispensing component engaged to the reservoir for applying the liquid, and a vibratory component for vibrating the massager device such that the user may simultaneously apply the liquid and provide a massaging effect.

### FIELD OF THE INVENTION

The present invention relates to a massager device, and more particularly to a massager device capable of applying a liquid.

### BACKGROUND OF THE INVENTION

Massager devices for recreational and therapeutic use are well known in the art. If desired, such massager devices may be used in combination with the separate application of lotions, oils and other liquids to the user's skin during a massage. However, such a simultaneous operation requires the user to manage both the liquid applicator and the massager device at the same time which can be cumbersome.

Therefore, there is a need in the art for a massager device that provides a massaging effect and is capable of storing and dispensing a liquid. There is a further need in the art for a massager device capable of providing a massaging effect and dispensing a liquid at the same time.

### SUMMARY OF THE INVENTION

A primary object of the present invention is to provide a massager device that allows a user to dispense a liquid and provide a massage effect without the need for separate devices.

A further object of the present invention is to provide a massager device that permits the user to provide a massage effect and dispense a liquid at the same time.

Another object of the present invention is to provide a massager device as noted above that permits interchangeable massage heads.

Yet another object of the present invention is to provide a massager device that is capable of storing and dispensing a liquid.

Still another object of the present invention is to provide a massager device having a liquid dispensing component capable of being sealed after liquid application.

Another further object of the present invention is to provide a massager device with a liquid dispensing component that is simple, reliable and easy to re-fill with a liquid.

In one embodiment, the present invention comprises a massager device comprising a massage head, the massage head adapted to engage a reservoir defining a chamber for storing a liquid, a liquid dispensing component in communication with the reservoir for dispensing the liquid, a vibratory component engaged to the reservoir for providing a massage effect, and an end cap operatively engaged to the vibratory component for controlling the operation of the massager device.

In another embodiment, the present invention comprises a massager device comprising a reservoir defining a chamber for storing a liquid, a liquid dispensing component engaged to the reservoir for dispensing the liquid, and a vibratory component engaged to the reservoir for providing a massaging effect, wherein the massager device is adapted to dispense said liquid and provide a massaging effect at the same time.

In yet another embodiment, the present invention comprises a massage head, the massage head adapted to engage a reservoir defining a chamber for storing a liquid, a liquid dispensing component in communication with the reservoir for dispensing the liquid, the reservoir including a cap member being removable from the reservoir for permitting the chamber to be refilled with the liquid, wherein the massage head has a generally phallic shape.

Additional objects, advantages and novel features of the invention will be set forth in the description that follows, and will become apparent to those skilled in the art upon examination of the following more detailed description and drawings in which like elements of the invention are similarly numbered throughout.

### BRIEF DESCRIPTION OF THE DRAWINGS

FIG. 1 is an elevated perspective view of the massager device according to the present invention;

FIG. 2 is an exploded view of the massager device according to the present invention;

FIG. 3 is another exploded view of the massager device according to the present invention;

FIG. 4 is a partial cross sectional front view of the massager device according to the present invention;

FIG. 5 is an enlarged cross sectional view of the massager device showing the massage head and liquid dispensing component according to the present invention;

FIG. 6 is a cross-sectional view taken along line 6-6 of FIG. 1 according to the present invention;

FIG. 7 is a cross-sectional view taken along line 7-7 of FIG. 5 according to the present invention;

FIG. 8 is an elevated perspective view of an embodiment of the massage head according to the present invention; and

FIG. 9 is a cross sectional view of another embodiment of the massage head showing the massager device in a liquid dispensation configuration according to the present invention.

### DETAILED DESCRIPTION OF THE INVENTION

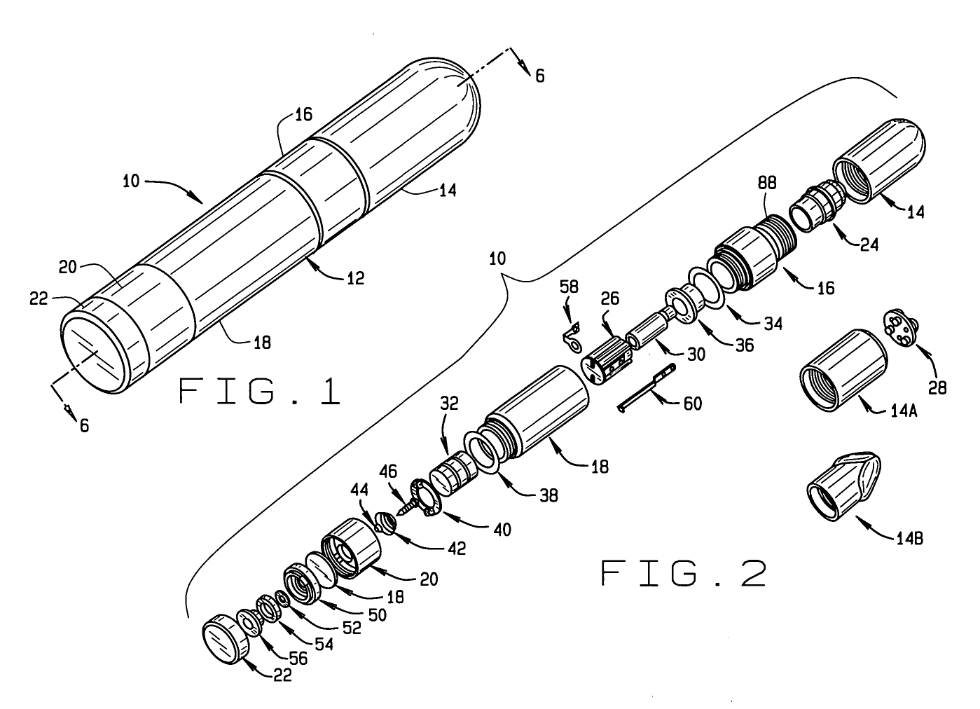

Referring to the drawings, the massager device with a liquid applicator according to the present invention is illustrated and generally indicated as 10 in FIG. 1. The massager device 10 comprises a body 12 including a massage head 14 that provides a massage effect engageable with a reservoir 16 that stores a liquid 78 for dispensation. As shown, the reservoir 16 is engaged to a vibratory component 18 for providing the massage effect when the massager device 10 is operated using a rotatable end cap 22 operatively engaged to the vibratory component 18 through a battery cover 20.

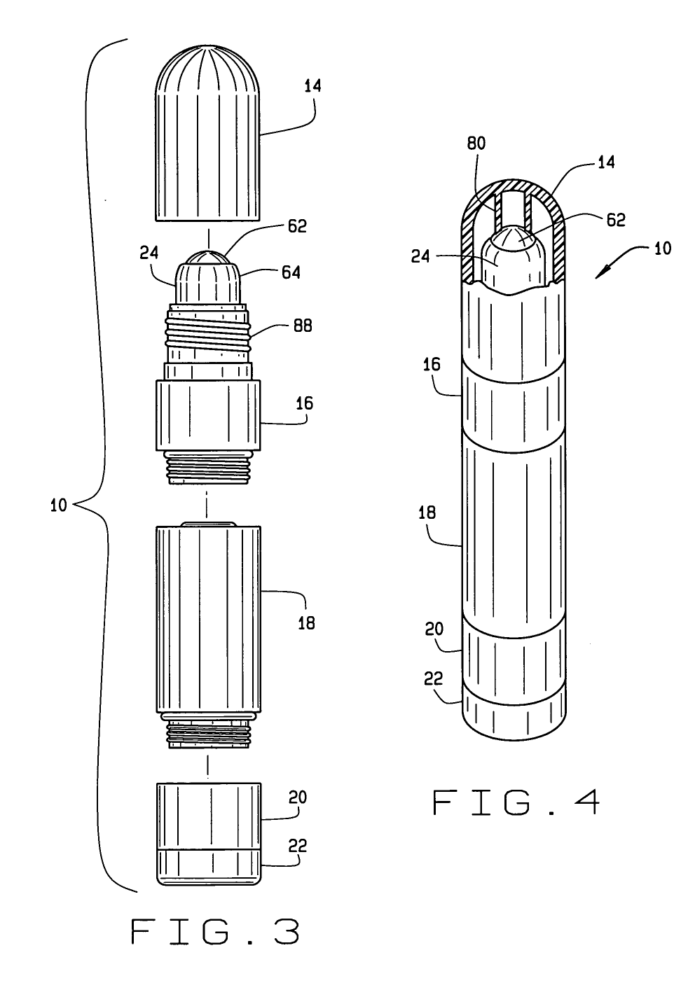

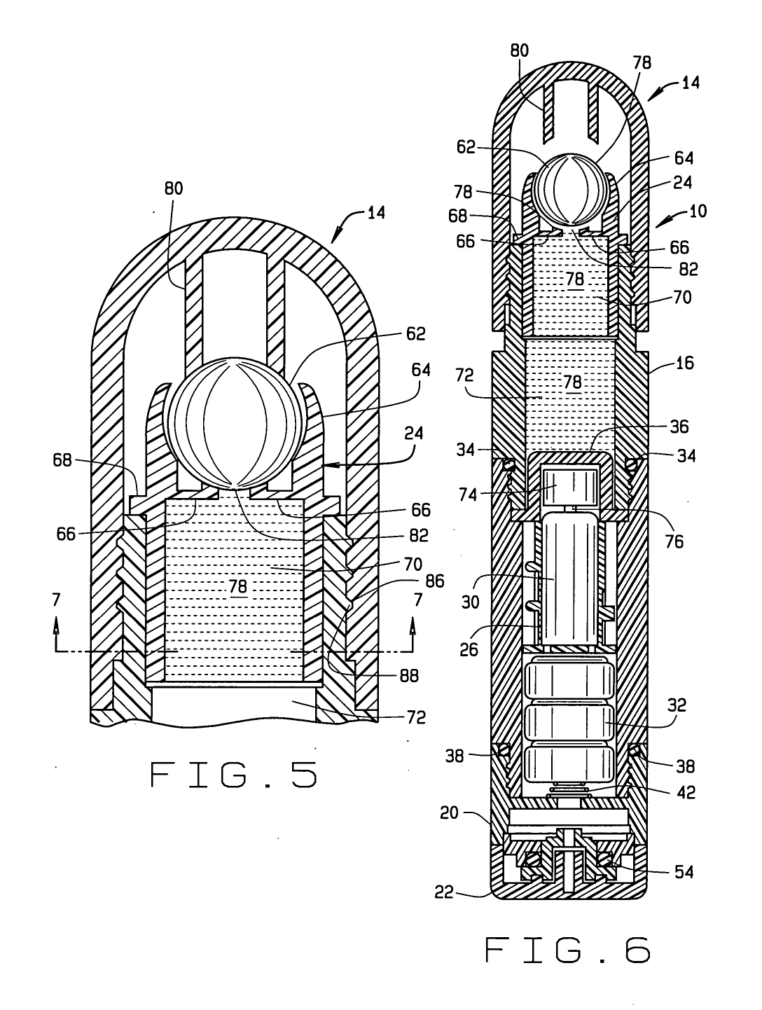

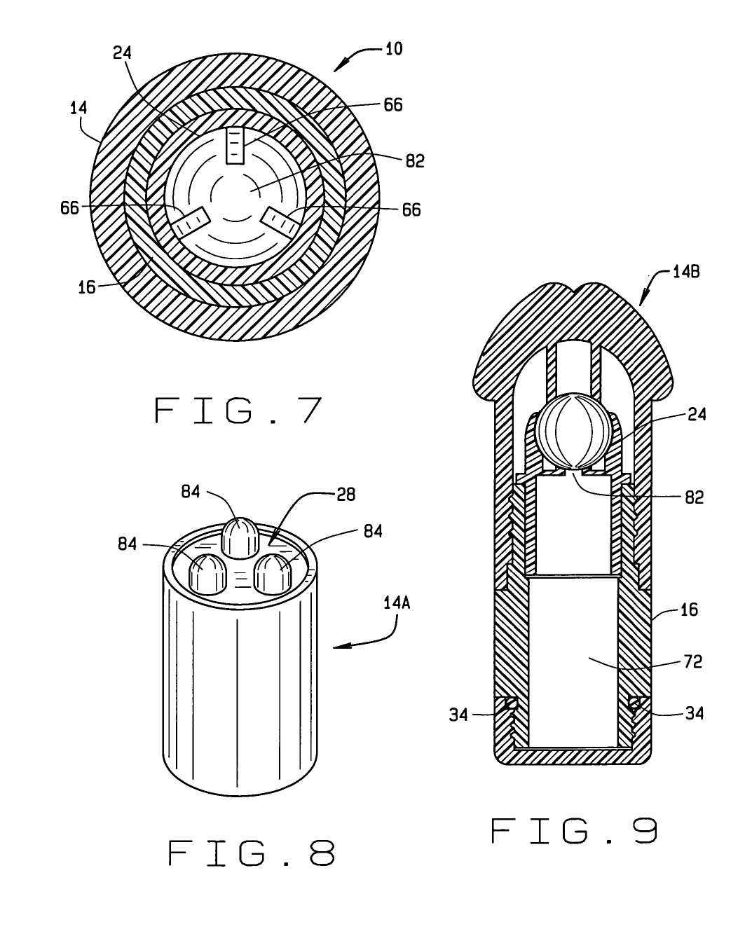

Referring to FIGS. 2 and 3, the reservoir 16 is engaged to a liquid dispensing component 24 that permits the dispensation of liquid 78 (FIG. 6) by the user when the massage head 14 is removed from the massager device 10. The liquid dispensing component 24 comprises a seat portion 64 that is rotatably engaged to a rolling dispensing ball 62 adapted to dispense liquid 78. As shown in FIGS. 5 and 6, a portion of the dispensing ball 62 is in fluid flow communication with liquid 78 stored in a chamber 70 through an opening 82 having a plurality of retainers 66 defined within the seat portion 64 of liquid dispensing component 24. The seat portion 64 is sized and shaped to engage the dispensing ball 62 such that ball 62 rotates within the seat portion 64. In this structural arrangement, liquid 78 from chamber 70 is permitted to lubricate and cover the dispensing ball 62 through a gap 100 defined between the dispensing ball 62 and seat portion 64 as the ball 62 rotates while also preventing liquid 78 from freely flowing outwardly from between the ball 62 and gap 100.

As further shown, the reservoir 16 defines a storage chamber 72 in fluid flow communication with chamber 70 when the reservoir 16 is engaged to the liquid dispensing component 24. A flange 68 is defined around the liquid dispensing component 24 that is adapted to engage the top portion of the reservoir 16, while external threads 88 are defined around one end of the reservoir 16 for engagement with corresponding internal threads 86 defined along the interior portion of massage head 14.

Referring specifically to FIG. 5, the interior portion of the massage head 14 defines a circular contact portion 80 that extends partially downwardly through the interior of head 14 and is adapted to contact the dispensing ball 62 when the massage head 14 is securely engaged to the reservoir 16 in order to lock the dispensing ball 62 securely in place. Preferably, massage head 14 has a smooth cylindrical shape adapted to apply a massage effect when the vibratory component 18 is operated. In the alternative, the massage head 14 has several other embodiments adapted to provide a massage effect to the user. As illustrated in FIGS. 2 and 8, the present invention contemplates an alternative massage head 14A engaged to a front bit 28 for providing a massage effect. The massage head 14A comprises a hollow cylindrical casing 90 engaged to the front bit 28 at one end with the bit 28 defining a plurality of nub-like protrusions 84 adapted to enhance the massage effect provided by massager device 10.

In another alternative embodiment shown in FIGS. 2 and 9, the present invention contemplates a massage head 14B having a generally phallic shape that is rotatably engaged to the reservoir 16 in a manner similar to the other two embodiments. The massage head 14B operates like massage heads 14 and 14A, which are used to encapsulate the liquid dispensing component 24 and provide a surface for imparting a massage effect to the user when the vibratory component 18 is in operation. Although massage head 14B has a phallic shape, other shapes and sizes suitable for a massaging surface are felt to fall within the scope of the present invention.

As illustrated in FIGS. 2 and 6, one end of the reservoir 16 defines exterior threads 75 adapted to engage interior threads 77 defined along the interior of vibratory component 18 which encases a vibrating element 26. The vibrating element 26 is operatively engaged to a battery 32 for providing power to element 26 and further includes a negative electrical pole 58 and a positive electrical pole 60 that provide an electrical circuit between the battery 32 and vibrating element 26. In addition, a cap member 36 and a sealing element 34 are interposed between the vibratory component 18 and the reservoir 16 for providing a fluid-tight seal such that fluid 78 from reservoir 16 in chamber 72 does not leak into the vibratory component 18 as well as providing an access port for permitting the user to re-fill chamber 72 with liquid 78. As further shown, vibrating element 26 comprises a motor casing 27 that encases a motor 30 that is operatively engaged to a rod 76 which rotates and spins an eccentric mass 74. The spinning action of the eccentric mass 74 by motor 30 causes the vibratory component 18 to vibrate during operation and provide a massaging effect. A spring 42 and contact plate 40 arrangement support the bottom portion of battery 32 in addition to a sealing element 38 that provides a water-tight seal between the vibratory component 18 and battery cover 20.

The other end of the vibratory component 18 defines exterior threads 92 adapted to engage interior threads 94 of battery cover 20. As shown in FIG. 2, the battery cover 20 encases a PCB component 48, locating ring 50, and contacting plate 52 when assembled, while a sealing ring 54 is provided between the battery cover 20 and end cap 22 for providing a fluid tight seal. As further shown, a sleeve bearing 56 is seated within end cap 22 for aligning and engaging the end cap 22 with battery cover 20.

In operation, the user may engage any one of the massage heads 14, 14A or 14B to the reservoir 16 when using the massager device 10 as a vibrator. In the alternative, the user may disengage the massage head 14 from the reservoir 16 and use the liquid dispensing component 24 to apply liquid 78 by rolling the dispensing ball 62 along the skin. The rolling action of the dispensing ball 62 along the skin continually lubricates and covers the outer surface of dispensing ball 62 with liquid 78 stored in chamber 70 for application by the user. In addition, the vibratory element 26 may be activated by rotating the end cap 22 so that the massager device 10 may be used to apply liquid 78 while simultaneously providing a massaging effect to the user if desired. Accordingly, the massager device 10 may be used to apply a liquid 78, such as an oil or other suitable liquid, while also effecting a massaging function using the massager device 10.

In the alternative, as shown in FIG. 9, the reservoir 16 may be directly engaged to the end cap 22 without the vibrating component 18 such that massager device 10 may be used solely as a liquid applicator.

It should be understood from the foregoing that, while particular embodiments of the invention have been illustrated and described, various modifications can be made thereto without departing from the spirit and scope of the invention as will be apparent to those skilled in the art. Such changes and modifications are within the scope and teaching of this invention as defined in the claims appended hereto.

What is claimed is:

1. A massager device comprising:
a massage head, said massage head adapted to engage a reservoir defining a chamber for storing a liquid,
a liquid dispensing component in communication with said reservoir for dispensing said liquid,
a vibratory component engaged to said reservoir for providing a massage effect, and
an end cap operatively engaged to said vibratory component for controlling the operation of the massager device.

2. The massager device according to claim 1, wherein said liquid dispensing component includes a seat portion defining an opening in communication with said chamber, said seat portion adapted to rotatably engage a dispensing ball for dispensing said liquid.

3. The massager device according to claim 2, wherein a portion of said dispensing ball is in communication with said liquid such that said liquid covers said dispensing ball for application of said liquid when said dispensing ball is rotated.

4. The massager device according to claim 1, wherein said liquid dispensing component provides a means for applying said liquid while also providing a massage effect when said massage head is disengaged from said reservoir.

5. The massager device according to claim 1, said vibratory component including a motor operatively engaged to a rod for rotating an eccentric mass.

6. The massager device according to claim 1, wherein said massage head has a generally phallic shape.

7. The massager device according to claim 1, wherein said massage head includes a hollow cylindrical casing engaged to a front bit, said front bit defining a plurality of nub-like protrusions.

8. The massager device according to claim 1, wherein said massage head defines a circular contact portion adapted to securely engage said dispensing ball when said massage head is engaged to said reservoir.

9. The massager device according to claim 1, wherein said reservoir is adapted to be re-filled with said liquid.

10. The massager device according to claim 2, wherein said dispensing ball is rotatable within said seat portion.

11. The massager device according to claim 2, wherein a portion of said dispensing ball is adapted to be in contact with said liquid in said chamber and is capable of dispensing said liquid as said dispensing ball rotates and is exposed externally from said chamber.

12. The massager device according to claim 2, wherein a gap is defined between said dispensing ball and said seat portion, said gap permitting a layer of said dispensing ball to be lubricated and covered with said liquid but preventing the free flow of fluid therethrough.

13. The massager device according to claim 1, wherein said reservoir is engaged to a cap member for accessing said chamber.

14. A massager device comprising:
a reservoir defining a chamber for storing a liquid,
a liquid dispensing component engaged to said reservoir for dispensing said liquid, and
a vibratory component engaged to said reservoir for providing a massaging effect, wherein the massager device is adapted to dispense said liquid and provide a massaging effect at the same time.

15. The massager device according to claim 14, further comprising an end cap engaged to said reservoir for controlling the operation of the massager device.

16. The massager device according to claim 14, wherein said liquid dispensing component is in fluid flow communication with said liquid stored in said chamber.

17. The massager device according to claim 14 said reservoir includes a cap member, said cap member being removable from said reservoir for permitting said chamber to be re-filled with said liquid.

18. The massage device according to claim 14, wherein said liquid dispensing component comprises a dispensing ball rotatably engaged to a seat portion, said dispensing ball in fluid flow communication with said liquid for dispensing said liquid.

19. The massager device according to claim 14, further comprising a massage head, said massage head adapted to engage said reservoir.

20. A massager device comprising:
a massage head, said massage head adapted to engage a reservoir defining a chamber for storing a liquid,
a liquid dispensing component in communication with said reservoir for dispensing said liquid, said reservoir including a cap member being removable from said reservoir for permitting said chamber to be refilled with said liquid, wherein said massage head has a generally phallic shape.
